(19) United States
(12) Patent Application Publication
(10) Pub. No.: US 2024/0225063 A9
(43) Pub. Date: Jul. 11, 2024

(54) BIOTECHNOLOGICAL PRODUCTION OF MEAT-LIKE FLAVOURINGS

(71) Applicant: SYMRISE AG, Holzminden (DE)

(72) Inventors: Tobias TRAPP, Holzminden (DE); Torsten GEISSLER, Einbeck (DE); Jakob Peter LEY, Holzminden (DE); Jens KOCH, Eschershausen (DE); Gerhard KRAMMER, Holzminden (DE); Suzan YALMAN, Langgöns (DE); Marco FRAATZ, Gießen (DE); Holger ZORN, Wettenberg (DE)

(21) Appl. No.: 18/547,173

(22) PCT Filed: Feb. 22, 2021
(86) PCT No.: PCT/EP2021/054282

§ 371 Date: Aug. 21, 2023

(51) Int. Cl. A23L 27/26; A23L 27/24; A23L 31/00

(52) U.S. Cl. CPC A23L 27/26; A23L 27/24; A23L 31/00

(57) ABSTRACT

The present invention primarily relates to a process for production of one or more flavourings selected from the group consisting of non-saturated aldehydes, non-saturated lactones and organosulphuric compounds, the process comprising providing a culture medium comprising one or more components supporting growth of a fungus from the phylum Basidiomycota and being convertable to one or more flavourings selected from the group consisting of non-saturated aldehydes, non-saturated lactones and organosulfur aroma compounds; cultivating a fungus from the phylum Basidiomycota in or on the culture medium under conditions that support the growth of the fungus and formation of the one or more flavourings, and optionally recovering the one or more flavourings.

The present invention primarily relates to a process for production of one or more flavourings selected from the group consisting of non-saturated aldehydes, non-saturated lactones and organosulphuric compounds. The present invention further concerns a process for production of a natural flavouring having a meat-like note, various uses of a culture medium and uses of a fungus from the phylum of Laetiporus. Also encompassed is a composition as well as its use as or in a preparation for nutrition.

The flavor of meat evolves through complex interactions between aroma and taste molecules. Significant differences in the aroma molecule composition exist between the different types of meat, which results in their characteristic flavor attributes. By means of determining the flavor dilution factors, a number of key aroma compounds were identified as characteristic for chicken and beef meat.

The complex aroma molecule composition of meats comprises (amongst others) unsaturated aldehydes, such as decadienal isomers, and organosulphuric compounds, such as 3-methyl-2-furanthiol, bis(2-methyl-3-furyl)disulfide, 2,5-dimethyl-3-furanthiol and 2-furfurylthiol. These organosulphuric compounds with very low odour thresholds are related with distinct “meaty” aroma notes. The molecules are not intrinsic in raw meat but formed typically during heating or cooking processes. The generation of the organosulphuric compounds is initiated by Maillard reactions of reducing sugars with sulphur-containing amino acids. By contrast, the formation of the unsaturated aldehydes evolves via autoxidation of unsaturated fatty acids. For industrial production, thermal processing enforcing the mentioned reactions is typically applied to generate the mentioned target compounds.

Basidiomycetes, a phylum within the kingdom of fungi, possess a broad and unique portfolio of enzymatic activities, which allow them to perform their essential part in ecosystems. Most of the edible mushroom species belong to the phylum of Basidiomycetes. These enzyme activities show tremendous potential for the biotechnological production of ingredients for food, fragrance, and pharmaceutical purposes.

One interesting example is the Basidiomycete is Laetiporus sulphureus (LSU) (also: Polyporus sulfureus), commonly known as “chicken of the woods”. The edible fruiting bodies of this species can be found in forests all over the world and are highly appreciated due to their characteristic “chicken meat”-like taste. The aroma molecules of wild fruiting bodies have been investigated. The mycelia of LSU have been studied for diverse research purposes, e.g. with respect to extracellular polysaccharides, pigments, lectins and aroma molecules. The mycelia of LSU in submerged cultivation were described to impart a “seasoning”-like aroma. This sensory impression was primarily related to the particular conversion of the amino acid L-isoleucine to 3-hydroxy-4,5-dimethyl-2(5H)-furanone (sotolon) and the formation of further furanones. However, volatile organosulphuric compounds with “meat”-like aroma, such as 2-methyl-3-furanthiol, were not detected in any of the mentioned studies—despite the characteristic name of the fungus.

Unlike well-known LSU, related Laetiporus species such as Laetiporus portentosus (LPO), Laetiporus persicinus (LPER) or Laetiporus montanus (LPM) have been hardly researched for biotechnological purposes so far, neither their fruiting bodies nor the mycelia. Moreover, LPOR, LPO and LPM have not been described in the context of aroma or flavor thus far.

Over the past years, a trend towards a vegetarian or vegan diet has been observed. Despite this trend, many consumers like the taste and smell of meat and, thus, meat substitutes have made it onto the market. Moreover, an increasing demand for clean-label, natural flavourings can be observed. In this regard, it has turned out that consumers prefer natural <X> flavourings (FTNS, 95/5), where 95% of the flavouring components within the flavouring must come from the named source within the description (FTNS), over natural flavourings, which do not mention the source material. Thus far, a (biotechnological) process for the natural production of volatile organosulphurs with “meaty” notes, such as 2-methyl-3-furanthiol, 2-methyl-(3-methylthio)-furan, 2-methyl-(3-methyldithio)-furan and 2-methyl-(3-methyltrithio)-furan, does, however, not exist.

Moreover, thousands of tons of food side-streams accumulate annually, which are primarily disposed. Examples include onion pomace and chicken fat. It would be desirable to better utilize these side-streams.

An object of the present invention was thus to overcome at least some of the aforementioned disadvantages of the state of the art, and in particular develop a “green” process for the production of a natural flavouring, in particular a natural<X> flavouring (FTNS, 95/5), having an intense “meaty” note. Moreover, the process should preferably be cheap, resource-efficient and integratable into existing food-related processes.

In a first aspect, the object is solved by a process as defined in appended claim 1.

The process for production of one or more flavourings selected from the group consisting of non-saturated aldehydes, non-saturated lactones and organosulphuric compounds comprises the following steps:
providing a culture medium comprising one or more components supporting growth of a fungus from the phylum Basidiomycota and being convertable to one or more flavourings selected from the group consisting of non-saturated aldehydes, non-saturated lactones and organosulfur aroma compounds;
cultivating a fungus from the phylum Basidiomycota in or on the culture medium under conditions that support the growth of the fungus and formation of the one or more flavourings, and optionally
recovering the one or more flavourings,
the fungus preferably being mycelium and/or
the one or more flavourings preferably including at least two compounds of two groups, the one or more flavourings more preferably including at least one compound of the group of non-saturated lactones and at least one compound of another group, the one or more flavourings most preferably including at least one compound of each group.

The present invention is based largely on the finding that a fungus from the phylum Basidiomycota (formerly class Basidiomycetes), in particular in the form of mycelium, allows the biotechnological production of new natural flavourings with intense meat-like notes. Thereby, a versatile platform is provided, which avoids the need for harsh manufacturing conditions, organic solvents or heavy metal catalysts, which are hardly avoidable in the case of chemical syntheses. The present invention thus provides an environmentally friendly alternative to chemical syntheses, which moreover meets the growing demand for natural <X> flavourings (FTNS, 95/5).

The term “flavouring” is used herein to denote a compound which, in aroma-active quantities, imparts a perceptible taste and/or odor. In this context, the term “aroma-active” refers to the amount of the compound in a preparation that is sufficient to elicit a sensory effect at odor, trigeminal and/or taste receptors. Such an effect may also manifest itself by reducing or masking an unpleasant taste- and/or odor-based sensory perception.

Furthermore, the process according to the invention is characterized by the fact that it offers the potential to utilize food side-streams (as described further below), which would otherwise be disposed, as a source of high-quality flavoring substances and could thus be profitably integrated into the value chain of existing food-related production processes.

Of particular interest to the present invention are taste and/or odor impressions that are perceived as pleasant. The assessment of whether a taste and/or odor impression is considered pleasant or rather unpleasant can be made by a sensory analysis by a trained panel based on an evaluation of the sensory impression between negative (pleasant) and positive (unpleasant). Additional levels such as very negative, neutral, and very positive can be provided for more precise classification. The determination of the notes of a flavouring to be evaluated, which may be present in a mixture along with further compounds, possibly further flavourings, can be carried out, for example, by means of gas chromatography-olfactometry. In the present case, the flavoring imparts a meaty-like note.

A preferred flavouring produced by the process of the present invention is selected from the group consisting of 2,4-decadienals, in particular (E,E)-2,4-decadienal, 5-butyl-2(5H)-furanone, and 2-methyl-3-(methylthio)-furan. Further preferred flavourings that can be obtained by the process of the invention are selected from those compounds mentioned in the example section. The exact composition in terms of chemical substance and amount of the flavoring(s) produced can not only be influenced by the culture medium and the particular fungus but can also be influenced by the harvesting time, i.e. the time when the cultivation is stopped. This makes it possible, among other things, to harvest at a time when a particularly pleasant aroma profile is present and/or a desired note predominates over rather undesired notes.

Both major parts of Basidiomycetes—fruiting bodies and mycelium—can be used for the cultivation. The major technological advantage of the mycelium is the diverse possibilities of cultivation, e.g. in emerged or submerged (or: liquid) form. In particular, submerged cultivation allows growing the mycelia in a resource-efficient manner in bioreactor systems.

The step of recovering the flavouring may involve separating the flavouring from the fungus, preferably fungal mycelium. For example, the fungus can be removed by liquid-solid separation using filtration, gravity or centrifugal force. Separation can also be achieved by thermal separation techniques such as distillation, whereby the fungus remains in the retentate and the flavouring can be recovered in the distillate. Another possibility to separate the flavouring from the fungus is by way of extraction. The flavouring can for instance be selectively adsorbed to a solid phase (solid state extraction, e.g. Symtrap®). After removal of the fungus, the flavouring may be further processed as desired and provided in liquid or solid form.

Prior to cultivation, a seed train may be provided. The purpose of a seed train is the generation of an adequate number of fungal cells for the inoculation of a production bioreactor (main culture) from volumes used for cell thawing or cell line maintenance. The seed train may include a pre-cultivation on one or more agar plates (preferably on malt extract agar) and/or in one or more culture flasks (preferably in sterilized liquid medium, e.g. malt extract or yeast extract, preferably pH adjusted to pH<2.5, for 5 to 14 d under stirring or agitation in darkness. Depending on the final scale used for the (main) cultivation, the seed train may further include a pre-cultivation in one or more (smaller) bioreactors.

For the (main) cultivation, the cultivation medium or components thereof, for example the carbon and/or nitrogen source, may be pasteurized or sterilized. Temperature-sensitive medium components and the fungus are added after pasteurization or sterilization. After pasteurization or sterilization, the cultivation medium is allowed to cool down. Then, the (optionally pre-cultured) fungus culture (inoculum) along with temperature-sensitive components and/or further components, such as thiamine and/or ascorbic acid in certain embodiments, may be added to the pasteurized or sterilized (parts of the) cultivation medium or components.

Further aspects and embodiments of the present invention will arise from the detailed description, which follows after the brief description of the drawings.

The drawings show:

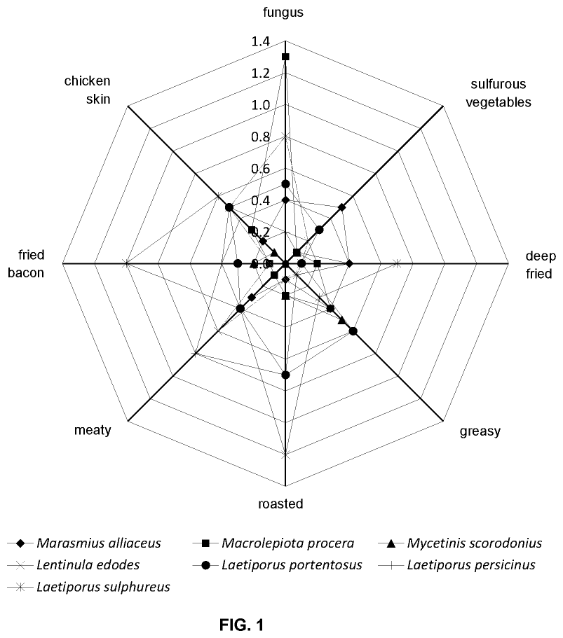

FIG. 1 Sensory analyses of submerged cultivated mycelia of different basidiomycetes in MEP media (supernatant, n=10 trained panelists, intensity scale 0-3).

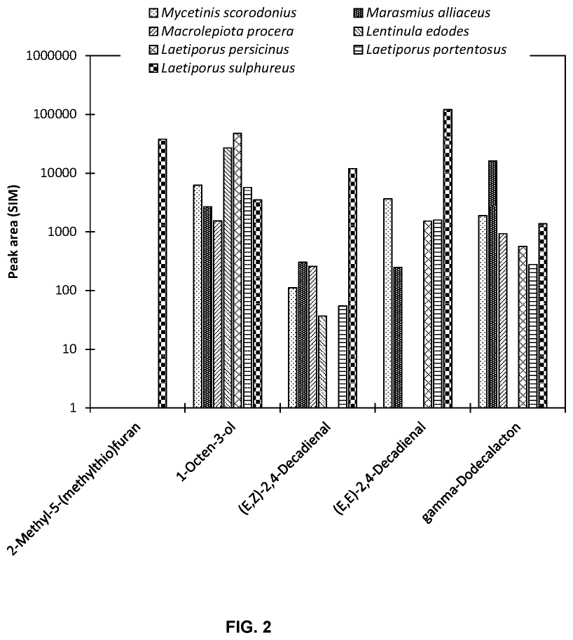

FIG. 2 Comparison of different submerged cultivated mycelia of different basidiomycetes in MEP media. Aroma analysis of supernatant by means of headspace-SPME-GC-MS of selected analytes.

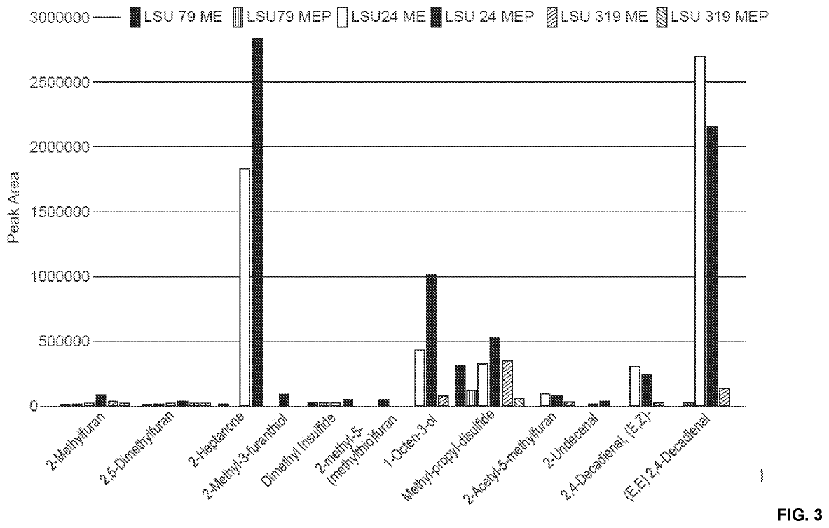

FIG. 3 Comparison of different L. sulphureus strains cultivated in ME or MEP media. Aroma analysis by means of headspace-SPME-GC-MS of selected analytes.

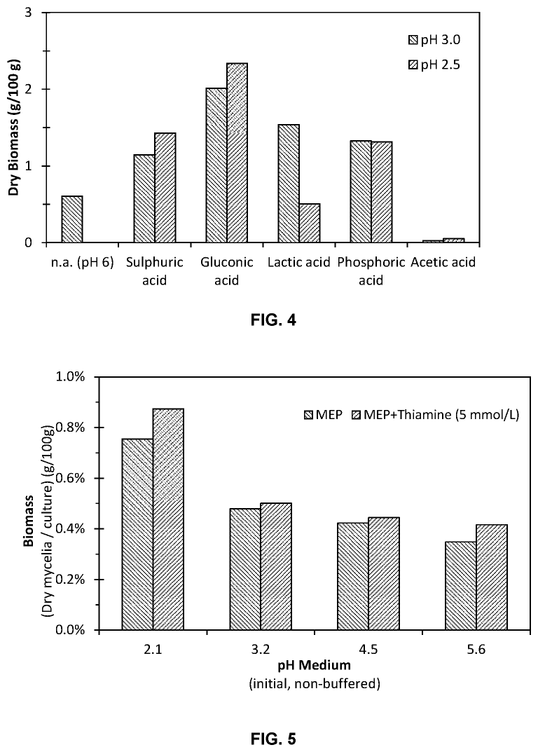

FIG. 4 Comparison of different acidifiers on biomass production: Submerged cultivation of LSU in MEYD medium adjusted to different initial pH values. (n.a.=pH not adjusted).

FIG. 5 Submerged cultivation of LSU in MEP medium adjusted to different initial pH values and without/with supplementation of thiamine hydrochloride. Gravimetric dry biomass determination after 13 d of cultivation in duplicate.

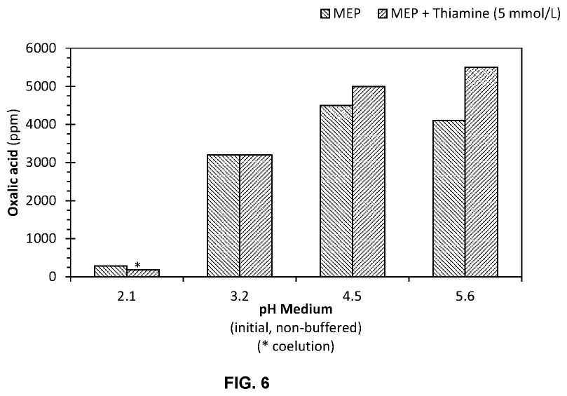

FIG. 6 Submerged cultivation of LSU in MEP medium adjusted to different initial pH values and without/with supplementation of thiamine hydrochloride. Determination of oxalic acid content by means of ion exchange chromatography.

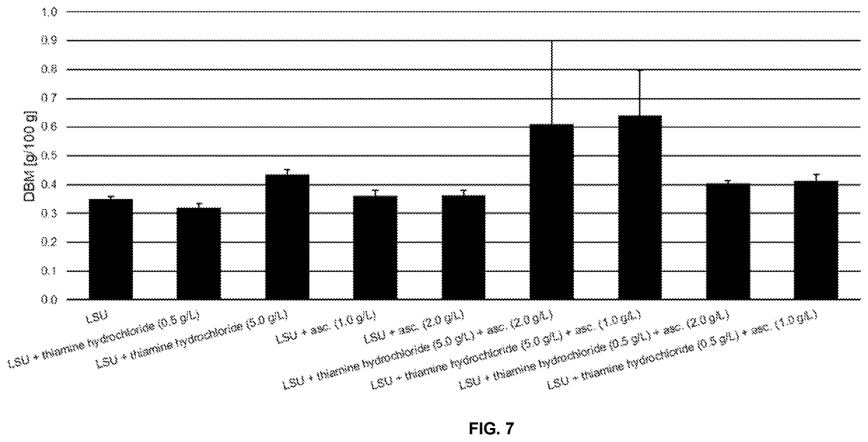

FIG. 7 Dry biomass (DBM) of LSU main cultures supplemented with thiamine hydrochloride and L-ascorbic acid; error indicators relate to biological duplicate determinations.

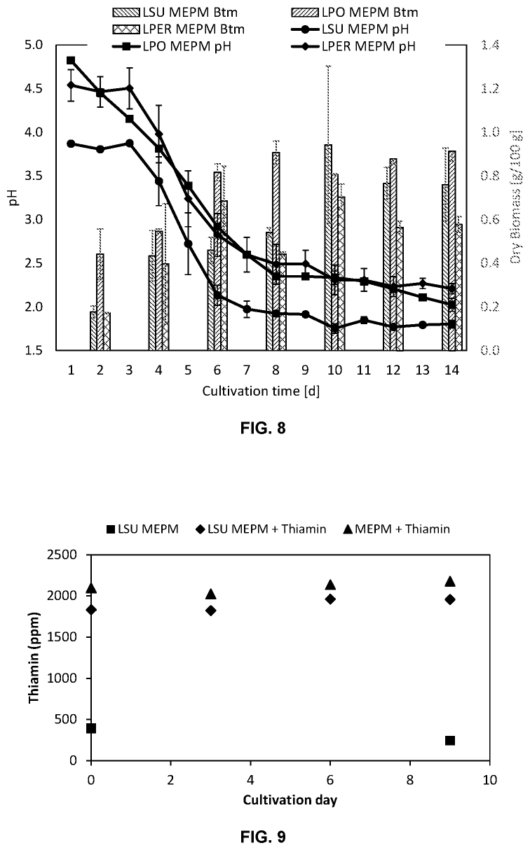

FIG. 8 Kinetic analysis of submerged cultivated mycelia of Laetiporus ssp. in MEPM media: Measurement of dry biomass and pH. Error indicators relate to biological duplicate determinations.

FIG. 9 Kinetic analyses of thiamine during submerged cultivation of LSU: Determination of thiamine levels in media with or without supplementation of thiamine hydrochloride. Chemical control medium without inoculation of LSU.

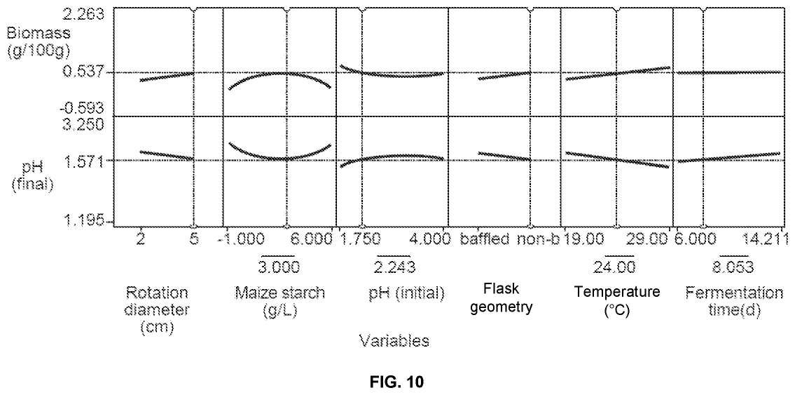

FIG. 10 Bioprocess optimization of submerged cultivation of LSU: Effect of bioprocess parameters on fungal growth. Developed models based on design of experiments.

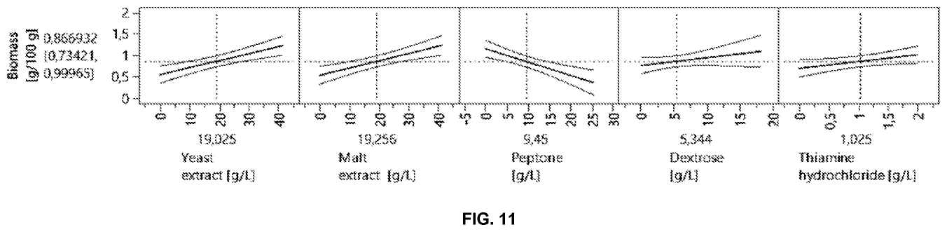

FIG. 11 Media optimization of submerged cultivation of LSU: Effect of media composition on fungal growth. Developed models based on design of experiments.

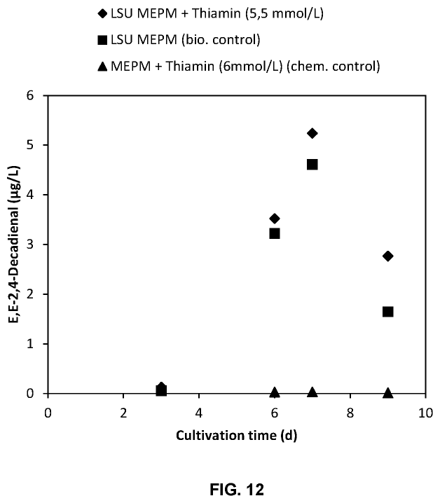

FIG. 12 Kinetic analyses of 2,4-decadienal formation during submerged cultivation of LSU: Estimation of 2,4-decadienal levels by means of SPME-GC-MS with internal standard ((E,Z)-(2-6)-nonadienal). Comparison with or without supplementation of thiamine hydrochloride. Chemical control medium without inoculation of LSU.

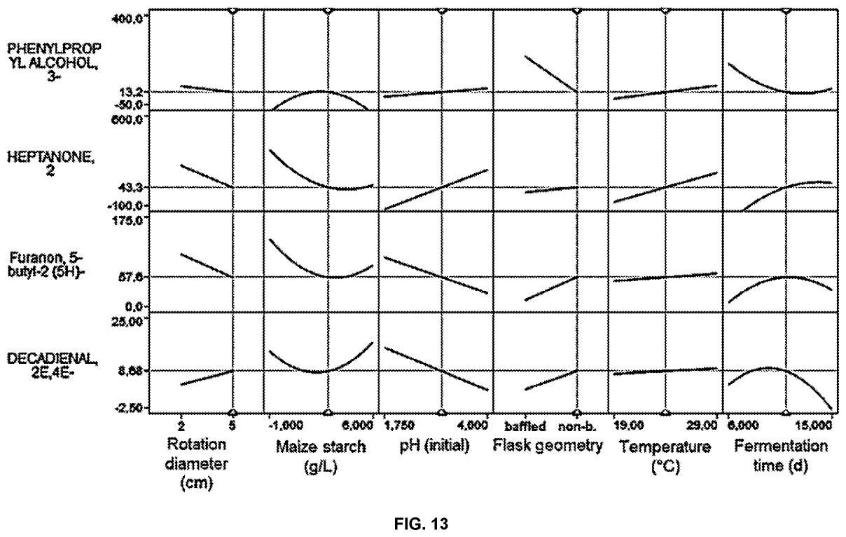

FIG. 13 Bioprocess optimization of submerged cultivation of LSU: Effect of bioprocess parameters on selected analytes. Developed models based on design of experiments.

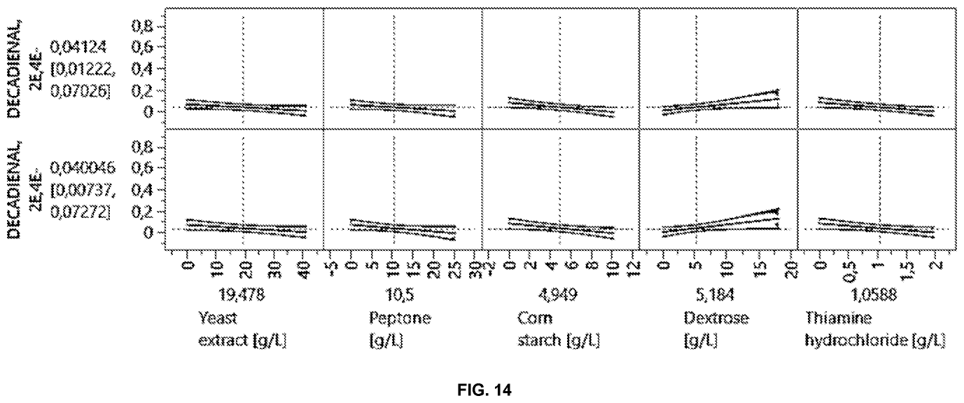

FIG. 14 Media optimization of submerged cultivation of LSU: Effect of media composition on formation of (E,E)-2,4-decadienal. Comparison of two developed models based on design of experiments.

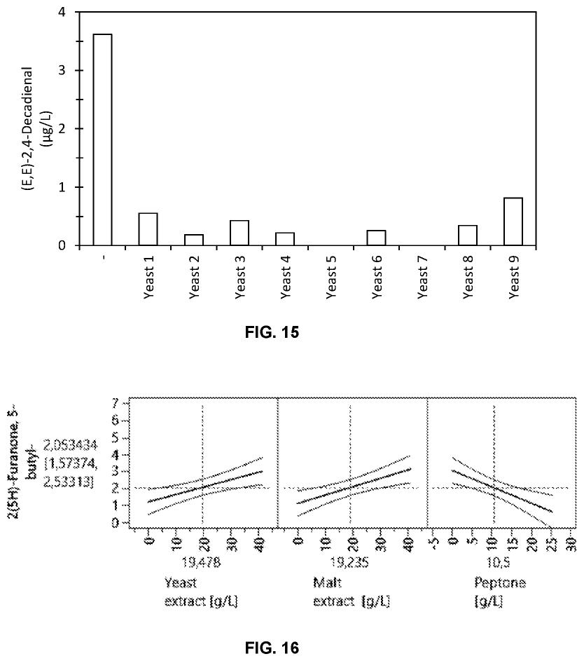

FIG. 15 Submerged cultivation of LSU in MED-Medium supplemented with types of yeast extracts (15 g/L each): Effect on formation of 2,4-decadienal. Estimation of concentrations by means of SPME-GC-MS with internal standard ((E,Z)-(2-6)-nonadienal).

FIG. 16 Media optimization of submerged cultivation of LSU: Effect of media composition on formation of 5-butyl-2(5H)-furanone. Developed models based on design of experiments.

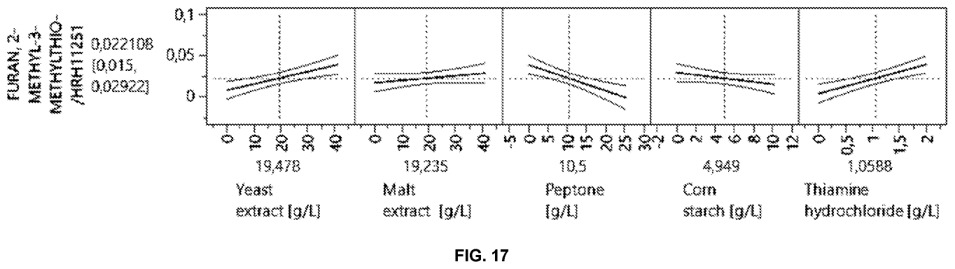

FIG. 17 Media optimization of submerged cultivation of LSU: Effect of media composition on formation of 2-methyl-3-(methylthio)-furan. Developed models based on design of experiments.

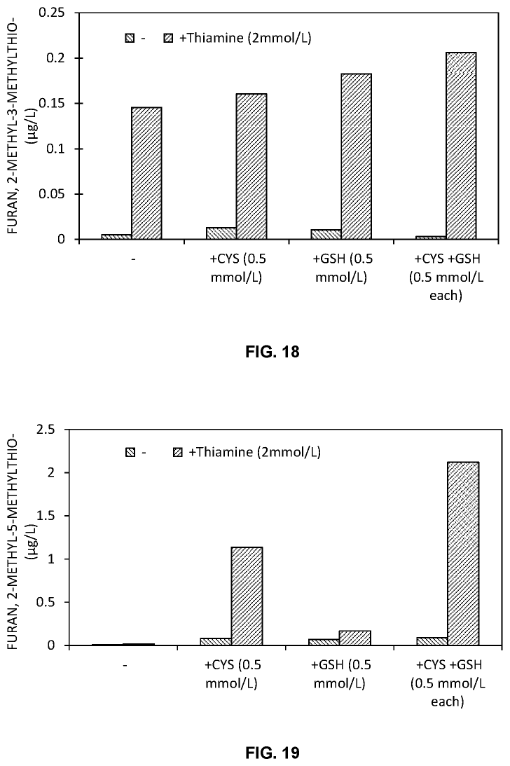

FIG. 18 Supplementation of cysteine (CYS), glutathione (GSH), and thiamine hydrochloride to submerged cultures of LSU in MED: Effect on formation of 2-methyl-3-(methylthio)-furan.

FIG. 19 Supplementation of cysteine (CYS), glutathione (GSH), and thiamine hydrochloride to submerged cultures of LSU in MED: Effect on formation of 2-methyl-5-(methylthio)-furan.

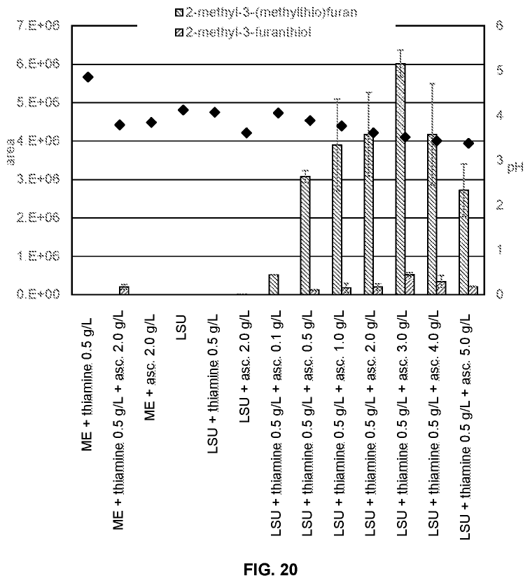

FIG. 20 Supplementation of L-ascorbic acid (asc.) and thiamine hydrochloride to submerged cultures of LSU in ME: Effect on formation of 2-methyl-3-(methylthio)-furan and 2-methyl-3-furanthiol. Determination in duplicate. Samples 1a—1c: non-inoculated media (chemical controls).

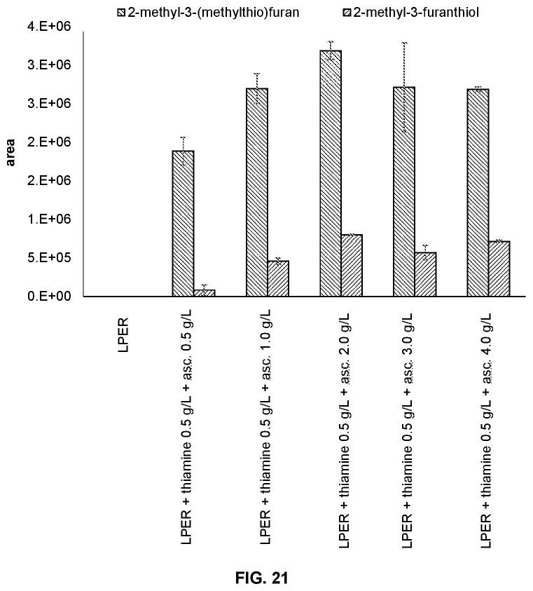

FIG. 21 Supplementation of L-ascorbic acid (asc.) and thiamine hydrochloride to submerged cultures of LPER in ME: Effect on formation of 2-methyl-3-(methylthio)-furan and 2-methyl-3-furanthiol. Determination in duplicate.

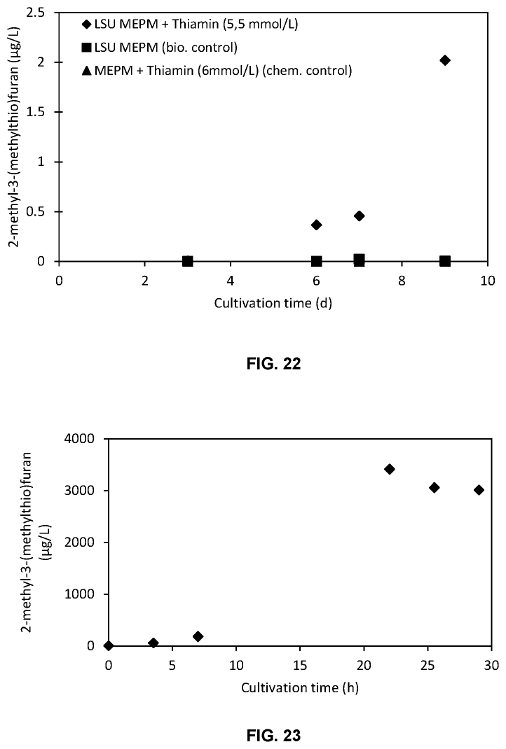

FIG. 22 Kinetic analyses of 2-methyl-3-(methylthio)-furan formation during 10 days of submerged cultivation of LSU in MEPM medium: Estimation of 2-methyl-3-(methylthio)-furan concentration by means of SPME-GC-MS with internal standard (3-heptanone). Comparison with or without supplementation of thiamine hydrochloride. Chemical control medium without inoculation of LSU.

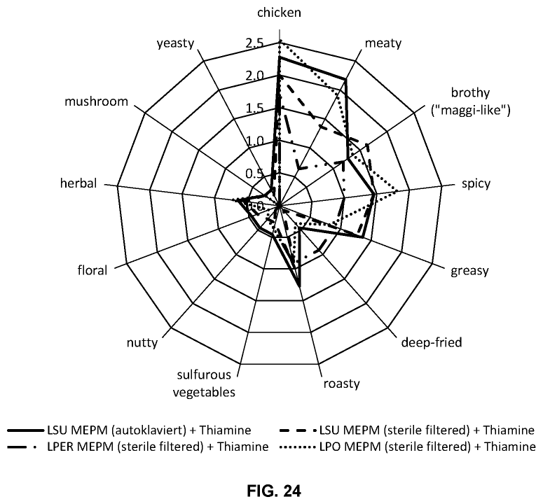

FIG. 23 Kinetic analyses of 2-methyl-3-(methylthio)-furan formation during the first 30 hours of submerged cultivation of LSU in ME medium supplemented with thiamine hydrochloride (2.7 g/L) and L-ascorbic acid (1.4 g/L): Estimation of 2-methyl-3-(methylthio)-furan concentration by means of SPME-GC-MS with internal standard (3-heptanone).

FIG. 24 Aroma profile of L. sulphureus (LSU) submerged cultivated in MEPM with or without supplementation of thiamine hydrochloride for 14 d. Descriptive sensory analysis with trained panelists (n=11) with intensity scale from 0 (“attribute not detectable”) to 5 (“very intense”).

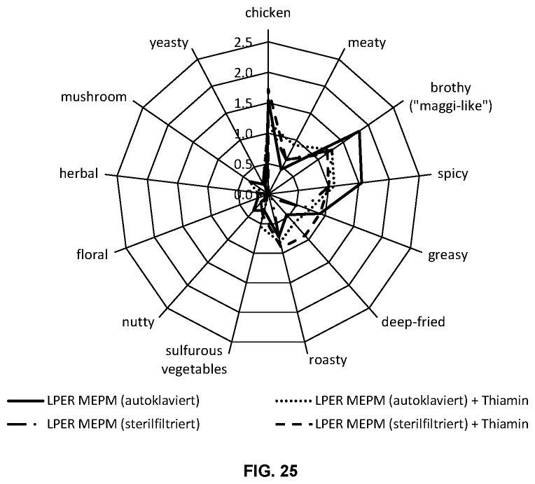

FIG. 25 Aroma profile of L. persicinus (LPER) submerged cultivated in MEPM with or without supplementation of thiamine hydrochloride for 14 d. Descriptive sensory analysis with trained panelists (n=11) with intensity scale from 0 (“attribute not detectable”) to 5 (“very intense”).

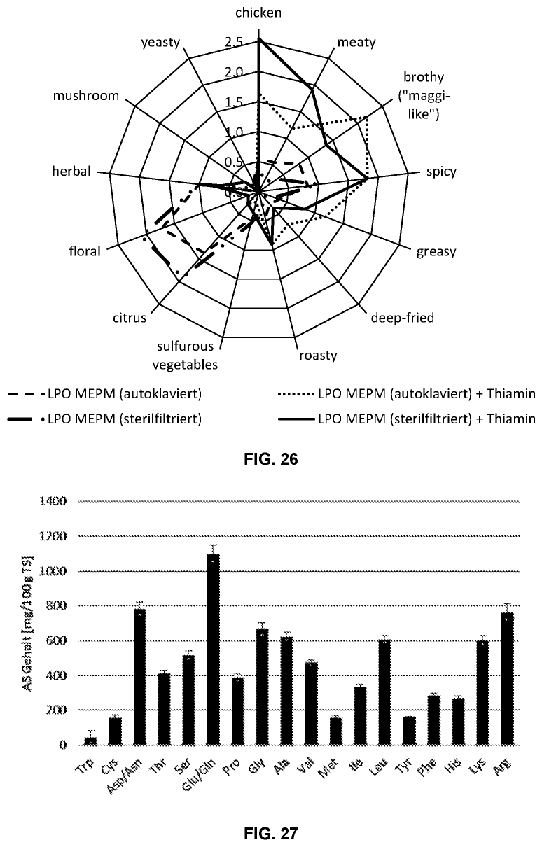

FIG. 26 Aroma profile of L. portentosus (LPO) submerged cultivated in MEPM with or without supplementation of thiamine hydrochloride for 14 d. Descriptive sensory analysis with trained panelists (n=11) with intensity scale from 0 (“attribute not detectable”) to 5 (“very intense”).

FIG. 27 Investigation of onion pomace as medium for biotransformation: Anaylsis of amino acid composition in mg/100 g dry matter, measured in triplicate.

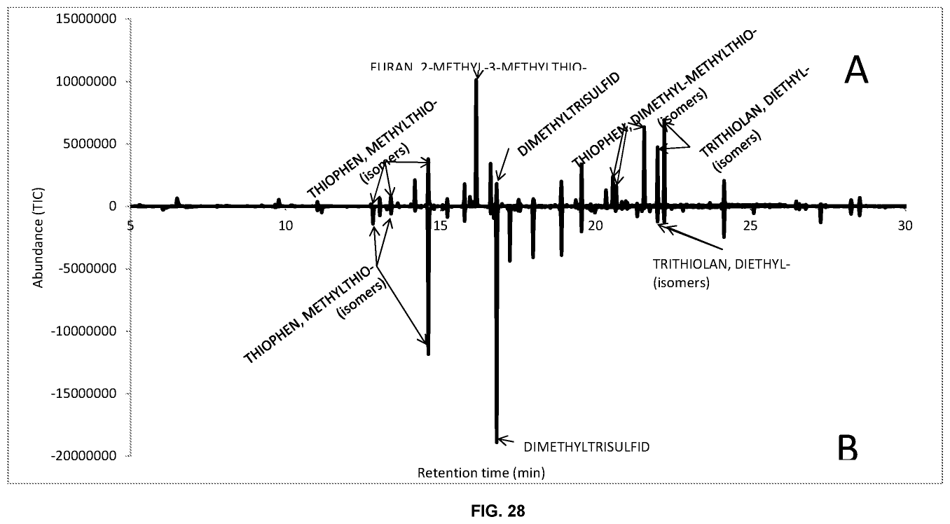

FIG. 28 Biotransformation of onion pomace by submerged culture of LSU: Comparison of SPME-GC-MS chromatograms after biotransformation by LSU (A) and chemical control without inoculation (B). Media composition: onion pomace fresh 30 g/L; L-ascorbic acid, 2 g/L; thiamine hydrochloride, 5 g/L.

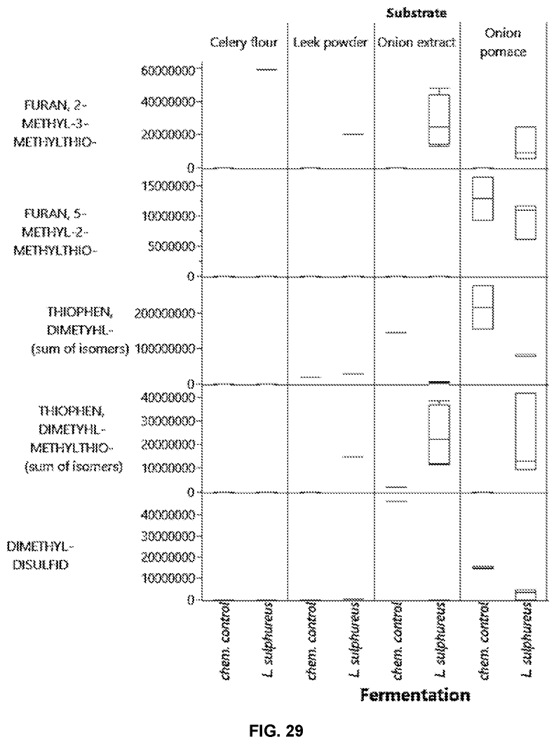

FIG. 29 Biotransformation of media containing parts of different plants: Screening of selected aroma analytes in chemical controls without inoculation (on the left) and after biotransformation by LSU (on the right) for different substrates. Respective concentrations in media: celery flour, 20 g/L; leek powder, 20 g/L; onion extract, 15-55 g/L; onion pomace fresh, 30-35 g/L. Further technical aids: L-ascorbic acid, 1-2 g/L; thiamine hydrochloride, 3-5 g/L. Samples analyses by means of SPME-GC-MS, total area counts used for evaluation. Isomers of dimethylthiophene and dimethylmethylthiothiophene accumulated. Diagram designed by means of statistical tool JMP 15.1.

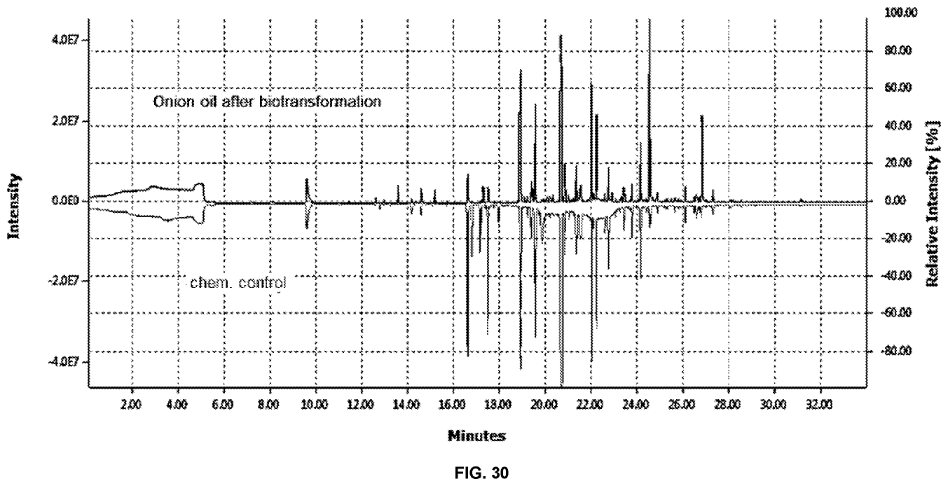

FIG. 30 Biotransformation of onion oil by submerged culture of LSU: Comparison of SPME-GC-MS chromatograms after biotransformation by LSU (above) and chemical control without inoculation (below). MYD-media supplemented with onion oil 7.5 μl/L.

As mentioned above, the one or more flavourings produced by the process of the invention have a meat-like note. The meat-like note can be more specifically described as an aroma profile that is characterized by (further differentiated) sub-notes including, for instance, mushroom-like, sulfurous vegetables, deep fried, greasy, roasted, meaty, deep fried bacon, brothy (“Maggi-like”) and chicken skin. The present invention provides a platform process, which is generally capable to provide an aroma profile including many, or substantially all of the above sub-notes, as for instance shown in the example section.

For example, the present invention may provide a flavouring (or as mentioned above, a flavouring mixture) that is characterized by 1, 2, 3, 4, 5, 6, 7, 8 or 9 of mushroom-like, sulfurous vegetables, deep fried, greasy, roasted, meaty, deep fried bacon, brothy (“Maggi-like”) and chicken skin notes. Moreover, by adapting the exact process conditions such as the fungus used for cultivation/production particular sub-notes can be emphasized.

In a preferred embodiment of the present invention, the fungus is selected from the geni of Laetiporus, Mycetinis, Marasmius, Lentinula and Marcrolepiota, preferably Laetiporus. Preferred species include Laetiporus sulphureus, Mycetinis scorodonius, Marasmius alliaceus, Lentinula edodes, Marcrolepiota procera, Laetiporus persicinus, Laetiporus portentosus and Laetiporus montanus. Laetiporus species, especially Laetiporus sulphureus, Laetiporus persicinus, Laetiporus montanus and Laetiporus portentosus are particularly preferred. The fruiting bodies of Laetiporus sulphureus are known as sulphur shelf, chicken of the woods, the chicken mushroom, or the chicken fungus because of its chicken-like taste.

As mentioned above, the culture medium is designed to support the growth of the fungus. For this purpose, it may include a carbon and a nitrogen source. Moreover, in preferred embodiments, the culture medium comprises or essentially consists of a food raw material and/or food side-stream. The food side-stream preferably serves as carbon and/or nitrogen source. The phrase “essentially consists of” means that at least 50 dry weight-%, preferably at least 60 dry weight-%, more preferably at least 70 dry weight-%, most preferably at least 80 dry weight-% of the total carbon and/or nitrogen source contained in the culture medium stem from the food raw material and/or the food side-stream.

The culture medium may optionally include one or more further components in addition to the food side-stream or the food raw material. A preferred optional component is a sulphur source, preferably a natural sulphur source. A preferred (preferably natural) sulphur source comprises or consists of thiamine, cysteine, glutathione or methionine, in particular thiamine. A natural sulphur source comprising thiamine includes for instance egg yolk, cashew kernel, or a fermentation product as described in WO 2004 106,557 or WO 2019 012,058. Thiamine can be also a salt, preferable the hydrochloride, or used as a mono-, di- or triphosphate or adenylated thiamine triphosphate or a mixture of these derivatives. Addition of the sulphur source, preferably thiamine, to the culture medium results in particularly intense meat-like notes. By including a sulphur source, preferably comprising or consisting of thiamine, the biomass production can be increased. In addition, the production of organosulphuric compounds, in particular 2-methyl-3-(methylthio)-furan and 2-methyl-3-furanthiol, can be greatly enhanced. The sulphur source can also be a combination of sulphuric compounds. Particularly preferred combinations include cysteine and/or glutathione in addition to thiamine. Unless otherwise dictated by the context, the acids and bases referred to herein encompass the corresponding salts. Specifically, the term “thiamine” in particular encompasses a hydrochloride salt, a phosphate salt (e.g. mono-, di- and triphosphate) including adenylated versions such as adenlyated thiamine triphosphate, and mixture thereof.

As regards the amount of the sulphur source, preferably thiamine, it is preferred that it ranges from 0.1 g/L to 10 g/L, preferably 0.2 g/L to 10 gl/L, more preferably 0.5 g/L to 5 g/L, relative to the total volume of the culture medium. The amounts given apply to thiamine in the form of its hydrochloride salt.

A further preferred component of the culture medium is an antioxidans and/or an organic acid, in particular ascorbic acid, preferably as its L-form. The antioxidans and/or the organic acid, in particular ascorbic acid, is preferably present in an amount of 0.1 g/L to 10 g/L, preferably 0.2 g/L to 5 g/L, more preferably 1 g/L to 4 g/L, most preferably 2 g/L to 3 g/L, relative to the total volume of the culture medium. By including an antioxidans and/or an organic acid, the biomass production can be increased. In the case of ascorbic acid, which is preferably present in the culture medium in combination with thiamine, additionally the production of organosulphuric compounds, in particular 2-methyl-3-(methylthio)-furan and 2-methyl-3-furanthiol, can be enhanced.

The pH value during cultivation is preferably acidic and may be buffered to range between pH 1.5 to 6, preferably 1.5 to 5, more preferably 1.5 to 4.5.

The cultivation is preferably conducted for at least 12 hours (h), 18 h, 24 h, 36 h, 2 days (d), 3 d, 4 d, 5 d, 6 d or at least 7 d and/or not more than 20 d, 19 d, 18 d, 17 d, 16 d, 15 d or not more than 14 d.

The temperature during cultivation preferably ranges from 15° C. to 35° C., preferably 20° C. to 28° C.

In the context of the present invention, all forms of cultivation are principally envisaged including submerged, emersed and solid-state cultivation, even though the specific form may have an influence on the flavouring(s) formed, i.e. on the aroma profile. A submerged cultivation is preferred, wherein the cultivation includes stirring or agitation.

The cultivation is preferably conducted in darkness.

A second aspect of the present invention pertains to a process for production of a natural flavouring having a meat-like note comprising the steps of:
providing a culture medium comprising one or more components supporting growth of a fungus from the phylum Basidiomycota and being convertable to a natural flavouring having a meat-like note;
cultivating a fungus from the phylum Basidiomycota in or on the culture medium under conditions that support the growth of the fungus and formation of the flavouring, and
optionally recovering the flavouring,
wherein the culture medium comprises a food raw material and/or a food side-stream, wherein the food raw material and/or food side-stream is selected from the group consisting of vegetables and parts thereof, fruits and parts thereof, grain and parts thereof, microbial cultures and parts thereof as well as animal parts,
wherein the fungus preferably is mycelium.

The second aspect of the present invention is based largely on the finding that food side-streams contain extremely interesting flavouring precursors which can be biocatalytically converted to flavourings having a meaty note. Furthermore, the second aspect is characterized by the fact that it offers the potential to utilize food side-streams, which would otherwise be disposed, as a source of high-quality flavoring substances and could thus be profitably integrated into the value chain of existing food-related production processes.

Although the present text uses the term “flavouring” in singular, the invention shall not be understood to be limited to the production of a single flavouring but encompasses the production of mixtures of two or more flavourings as well. The same applies to the term “food side-stream” and “food raw material”, which may consist of a food side-stream or food raw material from a single source or a mixture of food side-streams or food raw materials from two or more (different) sources.

Preferred food raw materials and/or food side-streams include one or more of the following:
plants or parts of plants from the genus Allium, preferably onion, garlic or leek,
plants or parts of plants from celery, carrot or apple,
meats, fats and bones of animals, preferably chicken,
yeast.

Optionally, the food raw materials and/or food side-streams are present in a processed form, for instance a pomace, oil, molasse, flour, powder, isolate, concentrate, extract or malt. Examples in this regard include (grain) malt, malt extract, corn starch, yeast extract, vegetable juice concentrate, fruit juice concentrate, meat powder, fat/broth powder.

Specific food raw materials and/or food side-streams include or consist of onion pomace, chicken meat powder (CMP), chicken fat, chicken broth powder, dehydrated chicken meat, chicken fat, onion juice concentrate, leek powder, celery flour, onion oil, garlic oil, or a mixture thereof. In one embodiment, the side-stream includes or consists of meat (waste) from chicken. In another embodiment, the side-stream includes or consists of plant parts from the genus Allium, preferably onion, garlic and/or leek. Particularly preferred food raw materials and/or food side-streams include or consist of onion pomace and/or chicken fat.

In a very preferred embodiment of the present invention, the culture medium comprises or consists of onion pomace and/or chicken fat, optionally a sulphur source, preferably thiamine, and optionally an antioxidans and/or an organic acid, preferably ascorbic acid.

A third aspect of the present invention concerns the use of a culture medium for increasing the biomass of a fungus selected from the group consisting of Laetiporus sulphureus, Laetiporus persicinus, Laetiporus portentosus and Laetiporus montanus and/or for suppressing formation of oxalic acid and/or for biotechnologically producing one or more compounds selected from the group consisting of non-saturated aldehydes, non-saturated lactones and organosulphuric compounds, wherein the culture medium comprises a carbon source, a nitrogen source, and optionally a sulphur source (as described herein).

A fourth aspect of the present invention pertains to the use of Laetiporus portentosus, Laetiporus persicinus, or Laetiporus montanus for the biotechnological production of a flavouring.

In a fifth aspect, the present invention relates to a composition, in particular prepared (preparable) according to the process as described herein, comprising at least one compound selected from the group consisting of non-saturated aldehydes, at least one compound selected from the group consisting of non-saturated lactones and at least one compound selected from the group consisting of organosulphuric compounds.

A sixth aspect of the present invention relates to the use of the composition as described herein as or in a preparation for nutrition, in particular as a flavoring. Accordingly, the present invention also relates to nutritional or edible preparations comprising or consisting of a composition according to the invention as described herein.

With respect to preferred and specific features and embodiments of the second to sixth aspects of the invention, reference is made to the first aspect of the invention, which defines corresponding features and embodiment of the second to sixth aspects of the invention.

The invention will now be described in more detail hereinafter with references to selected examples.

### EXAMPLES

1. Methods & Materials

Table 1 gives an overview of tested fungi, their abbreviation and their origin (DSMZ Leibniz Institute DSMZ-German Collection of Microorganisms and Cell Cultures, Braunschweig, Germany; CBS: CBS-KNAW culture collection, Westerdijk Fungal Biodiversity Institute, Utrecht, The Netherlands. Table 2 shows the tested L. sulphureus strains and their origin. Table 3 summarizes the tested culture media. Table 4 shows the tested food substrates and their origin.

TABLE 1
Cultivated basidiomycetes.

| Strain | Abbreviation | Origin |
|---|---|---|
| Laetiporus sulphureus | LSU | DSMZ Collection |
| Mycetinis scorodonius | MSC | CBS Collection |
| Marasmius alliaceus | MAL | Isolate from |
| | | Justus-Liebig- |
| | | University |
| Lentinula edodes | LED | CBS Collection |
| Marcrolepiota procera | MPR | Isolate from |
| | | Justus-Liebig- |
| | | University |
| Laetiporus persicinus | LPER | CBS Collection |
| Laetiporus portentosus | LPOR | CBS Collection |
| Laetiporus montanus | LPM | Isolate from |
| | | Justus-Liebig- |
| | | University |

TABLE 2
Screening of different L. sulphureus strains (used strains).

| Internal Nomenclature | Origin |
|---|---|
| LSU 24 | DSMZ Collection No. 1014 |
| LSU 79 | DSMZ Collection No. 2785 |
| LSU 319 | Isolate from Justus-Liebig-University |

TABLE 3
Media composition for cultivations.

| | Malt extract | Peptone | Corn starch | Dextrose | Yeast Extract |
|---|---|---|---|---|---|
| Medium | (g/L) | (g/L) | (g/L) | (g/L) | (g/L) |
| ME | 20 | — | — | — | — |
| MEP | 30 | 3 | — | — | — |
| MEPM | 30 | 3 | 3 | — | — |
| MEYD | 25 | — | — | 5 | 5 |
| MED | 10 | — | — | 5 | — |

TABLE 4
Used food substrates.

| Substrate | Origin |
|---|---|
| Onion pomace | Symrise, Holzminden |
| Chicken meat powder (CMP) | Symrise, Holzminden |
| Chicken fat/broth powder | Symrise, Holzminden |
| Dehydrated chicken meat | Symrise, Holzminden |
| Chicken fat | Symrise, Holzminden |
| Onion juice concentrate 80 Brix | Symrise, Holzminden |
| Leek powder | Symrise, Holzminden |
| Celery flour | Symrise, Holzminden |
| Onion oil | Symrise, Holzminden |
| Garlic oil | Symrise, Holzminden |

The aqueous media were autoclaved prior to inoculation. Unless otherwise indicated, cultivations were carried out in shaken flasks in darkness at a temperature of 24° C., an initial pH value of 2 and agitation speed of 150 rpm. These conditions remained substantially identical in all experiments unless the parameter has been intentionally varied to test its influence (e.g. pH value). Tested Temperature-sensitive supplements (e.g. thiamine hydrochloride, L-ascorbic acid, L-cysteine, L-glutathione, L-methionine) were dissolved in water, sterile-filtrated and added to the main medium after autoclavation.

2. Screening of Basidiomycetes

The cultivation of the fungi of the phylum Basidiomycota (Table 1) in the form of mycelia was carried out in submerged culture in darkness using shaked flasks and MEP medium (Table 3).The cultures were grown until maximal biomass formation was reached, namely for 5 d (MAL), 7 d (MPR, MSC, LED) or 14 d (LSU, LPO, LPER), respectively. The supernatant obtained after fermentation was examined by a panel of 10 trained panelists for their sensory properties. Sensory analysis was performed by smelling directly on the supernant. The results are shown in FIG. 1.

Subsequently, the recovered supernatant was subjected to headspace-SPME-GC-MS in order to determine the aroma compounds. The results are shown in FIG. 2.

Table 5 shows the result of descriptive sensory analyses by trained panelists for different L. sulphureus strains (Table 2) submerged cultivated in ME or MEP media (Table 3).

TABLE 5
Descriptive sensory analyses of different L. sulphureus strains.

| Strain/Medium | Sensory analysis (olfactory impression) |
|---|---|
| LSU 319 MEP | Meaty, sweet (pastry), greasy, savory |
| LSU 319 ME | Spicy, meaty, chicken broth, savory |
| LSU 24 MEP | Spicy, meaty (partly unpleasant), chicken |
| | broth, Maggi, sweet |
| LSU 24 ME | Pastry, meaty, sweet |
| LSU 79 MEP | Fresh milk, cream, sweet |
| LSU 79 ME | Fresh milk, cream, hot, curry |

The supernatants obtained from the cultivation of the different L. sulphureus strains cultivated in ME or MEP media were then examined by means of headspace-SPME-GC-MS. The results are shown in FIG. 3.

3. Identification of Flavour Compounds Formed by Mycelia of Laetiporus ssp.

Aroma (extract) dilution analyses of L. sulphureus submerged cultivated in MEPM medium was conducted. Odour-active compounds were identified based on determination of Flavour dilution (FD) factors. For this purpose, two analytical methodologies were compared. First, aroma dilution analysis by means of SBSE-TDU-GC-MS-Olfactometry on a non-polar DB-5 ms GC column according to Trapp et al. (Trapp, T., Jager, D. A., Fraatz, M. A. et al. Development and validation of a novel method for aroma dilution analysis by means of stir bar sorptive extraction. Eur Food Res Technol 244, 949-957 (2018)). Next, an aroma extract dilution analysis was performed based on liquid-liquid extraction with an azeotropic mixture of pentan and diethylether in combination with solvent-assisted flavor evaporation (SAFE). The odour-active compounds identified based on determination of FD factors are summarized in Table 6.

TABLE 6
Aroma extract dilution analysis of L. sulphureus submerged
cultivated in MEPM medium. Odour-active compounds
identified based on determination of Flavour dilution (FD)
factors by means of GC-MS-Olfactometry (polar column: VF-WAX).
RI = retention index; FD = flavour dilution factor.

| | RI | | | | |
|---|---|---|---|---|---|
| | (GC-MS/ | | | | tentatively |
| | MS-O; | RI | | perceived | identified |
| compound | VF-WAX) | (LIT.)^{a} | FD | odour | via |
| unknown | 975 | | 243 | onion | |
| unknown | 1105 | | 9 | musty, | |
| | | | | burned | |
| 1-octen-3-one | 1303 | | 9 | champignon | RI, MS, O |
| 2-heptanol | 1325 | 1327 | 729 | coco | RI, MS, O |
| 2-octanol | 1419 | 1412 | 81 | flower | RI, MS, O |
| acetic acid | 1449 | 1454 | 9 | vinegar | RI, MS, O |
| unknown | 1484 | | 9 | cacoa | |
| (E)-2-nonenal | 1530 | 1542 | 27 | green, | RI, MS, O |
| | | | | herbaceous | |
| unknown | 1608 | | 9 | cress | |
| unknown | 1647 | | 27 | cress, | |
| | | | | herbaceous | |
| unknown | 1704 | | 81 | grass | |
| (E,E)-2,4- | 1813 | 1795 | 81 | fatty, meaty, | RI, MS, O |
| decadienal | | | | bacon | |
| unknown | 1829 | | 27 | meaty | RI, MS, O |
| benzyl alcohol | 1861 | 1865 | 27 | flower, rose | RI, MS, O |
| unknown | 1901 | | 81 | flower, coco | |
| phenylethyl | 1911 | 1915 | 729 | rose | RI, MS, O |
| alcohol | | | | | |
| 5-butyl-2(5H)- | 1976 | 1956^{b} | 729 | coco, flower | RI, MS, O |
| furanone | | | | | |
| 3-phenyl- | 2044 | 2048 | 27 | sweetish | RI, MS, O |
| propanol | | | | | |
| sotolon | 2216 | 2190 | 729 | spicy | RI, MS, O |

4. Optimization of Biomass Production

4.1 Sulphur Sources

LSU mycelia were submerged cultivated in MEPM medium supplemented with different 5 sulphur sources (17 mM each), namely L-methionine, thiamine hydrochloride, L-glutathione and L-cysteine. After 13 days of cultivation, the mass of the generated biomass was determined. In addition, olfactory analysis by smelling directly on the supernatant was carried out.

The highest biomass formation was found for the cultures supplemented with thiamine, followed by the ones supplemented with glutathione. Also, the olfactory analysis revealed significant differences between the samples, whereof samples supplemented with thiamine resulted in the most interesting “meat”-like aroma profiles. The results are shown in Table 6.1

TABLE 6.1
LSU submerged cultivated in MEPM medium supplemented with
different sulphur sources (17 mM each): Olfactory analyses of
culture supernatants after different cultivation times.

| Supplement | 4 d | 8 d | 13 d |
|---|---|---|---|
| thiamine | yeasty | seasoning, | chicken broth, |
| | | chicken broth | meaty |
| L-methionine | sulphurous | sulphurous | sulphurous |
| | vegetables | vegetables | vegetables |
| L-glutathione | seasoning | chicken broth | chicken broth |
| L-cysteine | sulphurous | vegetables | vegetable broth |
| | vegetables | | |

4.2 Organic Acids

In another set of experiments, LSU mycelia were submerged cultivated in MEPM medium adjusted to an initial pH value of 2.5 and 3.0, respectively, using different acidifiers. After seven days of cultivation, the mass of the generated biomass was determined. The results are shown in FIG. 4. It was found that all acids lead to an increase of the biomass, whereby organic acids appeared to perform better than inorganic acids.

4.3 PH Value

Next, LSU mycelia were submerged cultivated in MEP medium adjusted to different initial pH values. Experiments werde performed with and without thiamine hydrochloride. After 13 days cultivation, the mass of the generated biomass was determined in duplicates using gravimetry. The results are shown in FIG. 5. It was found that the lower the initial pH value the higher the generated biomass. This effect was seen both in the presence and absence of thiamine hydrochloride.

In addition, the amount of oxalic acid was determined by ion exchange chromatography and plotted against the initial pH value, which is shown in FIG. 6. From these results, it was concluded that the higher biomass ovserved at lower pH values is probably due to prevention of the generation of oxalic acid at lower pH values.

4.4 Thiamine and Ascorbic Acid

In another round of experiments the influence of thiamine and/or ascorbic acid on the growth of LSU mycelia were further tested. The tested concentrations and combinations as well as the results on the dry biomass (DBM) after 12 days of cultivation are shown in FIG. 7.

4.5 Kinetic Analysis of Dry Biomass, PH Value and Thiamine Levels

Kinetic analysis of submerged cultivated mycelia of Laetiporus ssp. in MEPM media was carried out. For this purpose, dry biomass and pH was determined at several time points over a cultivation time of 14 days in total. The results are shown in FIG. 8.

FIG. 9 shows thiamine levels over the cultivation time in culture media with or without supplementation of thiamine.

4.6 Bioprocess Optimization

A process was developed and optimized to enhance the formation of fungal biomass. For this purpose, selected bioprocess parameters were varied as categorical or numerical variables with different levels in a Design of Experiment (DoE). Using DoE allowed to minimize the required sample amounts and to study the statistical interactions between the factors. The variables and levels and the respective ranges of the bioprocess parameter optimization are given in Table 7.

TABLE 7
Bioprocess optimization of submerged cultivation of LSU: Design
of Experiments (DoE): Response surface custom-design.
DoE created by means of statistical analysis tool JMP.

| Variables | Range | Levels |
|---|---|---|
| Time | 7 d-14 d | 4 |
| Temperature | 20° C.-28° C. | 3 |
| pH (initial) | 2.0-3.8 | 3 |
| Rotation diameter | 2 cm, 5 cm | 2 |
| Flask geometry | non-baffled, baffled | 2 |
| Maize starch | 0 g/L-5 g/L | 3 |

The effects of the bioprocess conditions on fungal growth as determined by DoE are shown in FIG. 10.

The same approach based on DoE was carried out to optimize the media composition used for submerged cultivation of LSU. There, the concentrations of yeast extract, malt extract, peptone, dextrose and thiamine hydrochloride were varied the results of which are shown in FIG. 11.

5. Optimization of Production of 2,4-Decadienals

2,4-decadienal formation over time during submerged cultivation of LSU was studied. 2,4-decadienals were estimated by means of SPME-GC-MS. Cultivation were carried out in the presence and absence of thiamine. As can be seen in FIG. 12, in the presence of thiamine more 2,4-decadienals were formed than in the absence of thiamine. An optimum of the (E,E)-2,4-decadienal concentration was found on day 7. Without fungus, no (E,E)-2,4-decadienal was formed.

Based on DoE, a model was developed for bioprocess optimization of submerged cultivation of LSA. FIG. 13 shows the effect of the bioprocess conditions on selected analytes, namely 3-phenyl propyl alcohol, 2-heptanone, 5-butyl-2 (5H)-furanon and E,E-2,4-Decadienals. FIG. 14 shows the predicted influence of the composition of the culture medium using the analyte (E,E)-2,4-decadienal as an example.

FIG. 15 again shows experimental results of submerged cultivations of LSU in MED-Medium supplemented with different types of yeast extract (15 g/L each). Interestingly, it was found that additional nitrogen sources such as yeast extracts reduced the formation of 2,4-Decadienal, as determined by means of SPME-GC-MS with (E,Z)-(2-6)-nonadienal as internal standard. This was also seen in the model obtained by DoE, which fact confirms the validity of the model.

6. Optimization of Production of Rare Unsaturated Lactones

Lactone formation during submerged cultivation of LSU in MEP medium over a cultivation time of 15 days was determined by means of SBSE-GC-MS. The results are summarized in Table 8 along with fungal growth parameters.

TABLE 8
Kinetic analyses of lactone formation during submerged cultivation of LSU in
MEP medium: Determination of fungal growth parameters and lactone concentrations
(in ppb) by means of SBSE-GC-MS using 2-nonanol as an internal standard.

| Cultivation day | 0 | 4 | 5 | 11 | 12 | 13 | 14 | 15 |
|---|---|---|---|---|---|---|---|---|
| Biomass (g/100 g) | 0 | 0.34 | 0.23 | 0.43 | 0.36 | 0.44 | 0.47 | 0.49 |
| pH | 5 | 1.93 | 1.85 | 1.76 | 1.66 | 1.68 | 1.68 | 1.68 |
| Total Volatiles (ppb) | | 1114 | 1133 | 792 | 1040 | 1151 | 870 | 1165 |
| Heterocyclic (ppb) | | | | | | | | |
| furanon, 5-butyl-2 (5H)- | | 30.7 | 53.5 | 71.9 | 74.4 | 97.0 | 97.5 | 111 |
| pentalactone, 3-methyl-gamma- | | 1.5 | 1.9 | 2.7 | 2.8 | 3.8 | 3.6 | 4.4 |
| octalactone, 4-methyl-gamma- | | 1.3 | 2.0 | 3.8 | 4.2 | 5.2 | 5.1 | 7.0 |
| hexalactone, 4-me-delta- | | 0.0 | 1.5 | 1.3 | 1.3 | 1.9 | 2.1 | 1.6 |
| furanon, 5-propyl-2(5H)- | | 0.4 | 0.6 | 0.8 | 0.8 | 1.1 | 1.6 | 2.0 |
| valerolactone, gamma- | | 2.2 | 2.2 | 0.8 | 0.0 | 0.0 | 0.0 | 0.0 |

Using DoE, the effect of the medium composition on the formation of 5-butyl-2(5H)-furanone by submerged cultivation of LSU was predicted. The results are shown in FIG. 16.

7. Optimization of Production of Organosulphuric Aroma Compounds

Using DoE, the effect of the medium composition on the formation of 2-methyl-3-(methylthio)-furan by submerged cultivation of LSU was predicted. The results are shown in FIG. 17. A significant, positive correlation between the formed amounts of 2-methyl-3-(methylthio)-furan and the concentrations of yeast extract or thiamine hydrochloride was found.

7.1 Influence of Sulphur Source on the Production of Organosulphuric Aroma Compounds

The influence of cysteine (CYS), glutathione (GSH), and thiamine hydrochloride as examples for different sulphur sources on the production of organosulphuric aroma compounds of submerged cultures of LSU in MED medium was tested. The cultivations were carried out for 7 d. FIGS. 18 and 19 show the results for 2-methyl-3-(methylthio)-furan and 2-methyl-5-(methylthio)-furan, respectively.

7.2 Influence of Ascorbic Acid and Thiamine on the Production of Organosulphuric Aroma Compounds

The influence of L-ascorbic acid (asc.) and thiamine hydrochloride on the production of organosulphuric aroma compounds, specifically 2-methyl-3-(methylthio)-furan and 2-methyl-3-furanthiol, of submerged cultures of LSU in ME medium and submerged LPER in ME medium was tested. FIGS. 20 and 21 show the results.

7.3 Kinetic Analyses of Organosulphuric Aroma Compound Formation

2-methyl-3-(methylthio)-furan formation during submerged cultivation of LSU in MEPM medium over a cultivation time of 10 days was determined by means of SPME-GC-MS. Cultivations were carried out with and without thiamine hydrochloride. The results are shown in FIG. 22.

Then, 2-methyl-3-(methylthio)-furan formation during submerged cultivation of LSU in ME medium during the first 30 hours was determined by means of SPME-GC-MS. Culture medium was supplemented with thiamine hydrochloride and ascorbic acid. The results are shown in FIG. 23.

Interestingly, the concentration of 2-methyl-3-(methylthio)-furan reached its maximum already after 22 h, before sharply plummeting until day 3. On day 6, the concentration started to slightly increase again until the end of the cultivation.

7.4 Aroma Profile of Cultivated Basidiomycetes

The aroma profile of LSU, LPER and LPO, respectively, submerged cultivated in MEPM media with or without supplementation of thiamine hydrochloride for 14 d was determined by descriptive sensory analysis with trained panelists (n=11) with an intensity scale from 0 (“attribute not detectable”) to 5 (“very intense”). The results are shown in FIGS. 24, 25 and 26, respectively.

Metabolic formation of 2-methyl-3-(methylthio)furan was elucidated by supplementing submerged cultures of LPER with non-labeled and ¹³C-labeled isomers of thiamine. The mass spectrum of formed 2-methyl-3-(methylthio)furan after supplementation with thiamine-(4-methyl-¹³C-thiazol-5-yl-¹³C₃) hydrochloride showed a mass fragment shift of +3 occurred (data not shown).

2,5-dimethyl-3-methylthiothiophene was identified in LSU cultivated in liquid medium (malt extract 20 g/L, thiamine hydrochloride 5 g/L, L-ascorbic acid 2 g/L) supplemented with 2,5-Dimethylthiophene (500 ppm). The SPME-GC-MS chromatograms with/without supplementation and chemical control without inoculation of LSU were compared to each other. Comparison of measured mass spectrum identified as 2,5-dimethyl-3-methylthiothiophene (retention index on polar column: 1221) with spectrum from internal database (data not shown).

8. Cultivation of Mycelia of Basidiomycetes in Side-Streams from the Food Industry

Submerged cultivations of LSU in different media containing side-streams from the food industry were examined.

8.1 Biotransformation of Media Containing Vegetables or Fruits

First, LSU were cultivated in different media containing vegetables or fruits. Fermented samples were then sensorily evaluated by trained panelists with respect to “meat”-like odour (scale: 0 (“not meaty”)-3 (“very meaty”). The culture media are depicted in Table 9, wherein the respective foodside-streams are given in the first column and supplementary media components M1 to M3 are given in the last three columns.

TABLE 9
Submerged cultivation of L. sulphureus in different
media containing side-streams from the food industry.
Sensory evaluation of fermented samples by trained
panelists with respect to “meat”-like odour
(scale: 0 (“not meaty”)-3 (“very meaty”).

| Substrate | Substrate Concentration | | M1 | M2 | M3 |
|---|---|---|---|---|---|
| Palatinose molasses | 75 | mL/L | 1 | 2.5 | 2.3 |
| | 100 | mL/L | 0 | 2.5 | 3 |
| | 150 | mL/L | 0.3 | 2 | 1.5 |
| | 150 | mL/L (Blank) | 0 | 0 | 0 |
| Carrot pomace | 21.75 | g/L | 1 | 1.3 | 1 |
| | 29 | g/L | 1 | 1.3 | 1.3 |
| | 43.5 | g/L | 1 | 0.5 | 0.5 |
| | 43.5 | g/L (Blank) | 0 | 0 | 0 |
| Apple pomace | 8.4 | g/L | 0.3 | 0.5 | 0.8 |
| | 11.2 | g/L | 0.5 | 1.5 | 2 |
| | 16.8 | g/L | 1.5 | 1 | 1.3 |
| | 16.8 | g/L (Blank) | 0 | 0 | 0 |
| Onion pomace | 23.63 | g/L | 1 | 0.7 | 0.7 |
| | 31.5 | g/L | 0.3 | 0.3 | 0.3 |
| | 47.25 | g/L | 0 | 0.7 | 0.7 |
| | 47.25 | g/L (Blank) | 0 | 0 | 0 |

The compositions of the supplementary media components M1 to M3 are as follows:

M1 Medium (pH 6)

| | | |
|---|---|---|
| L-Aspartate Sodium Monohydrate | 6.24 | g/L |
| Ammonium nitrate | 2.4 | g/L |
| Potassium dihydrogenphosphate | 1.5 | g/L |
| Manganese sulfate hydrate | 0.5 | g/L |
| Trace element solution | 1 | mL/L |

M2 Medium (pH 6)

| | | |
|---|---|---|
| Yeast extract | 3 | g/L |
| Potassium dihydrogenphosphate | 1.5 | g/L |
| Manganese sulfate hydrate | 0.5 | g/L |
| Trace element solution | 1 | mL/L |

M3 Medium (pH 6)

| | | |
|---|---|---|
| Yeast extract | 3 | g/L |
| Potassium dihydrogenphosphate | 1.5 | g/L |
| Manganese sulfate hydrate | 0.5 | g/L |
| D-Glucose monohydrate | 3 | g/L |
| Trace element solution | 1 | mL/L |

8.2 Biotransformation of Media Containing Parts of Chicken

LSU was then submerged cultivated in culture media containing either chicken meat powder (CMP) (18 g/L), chicken fat/broth powder (10 g/L) or dehydrated chicken meat (10 g/L) as substrates. Further technical aids in the media were L-ascorbic acid (2 g/L) and thiamine hydrochloride (5 g/L). After the cultivation, SPME-GC-MS chromatograms were taken. As a control, a corresponding chromatogram was taken from a culture medium that was not inoculated (data not shown). The peak areas of identified organosulphuric compounds obtained by means of SPME-GC-MS are summarized in Table 10.

A similar experiment as above was then performed with pure chicken fat. Specifically, LSU was submerged cultivated in a biphasic culture medium containing chicken fat (50 g/L CMP; 10 g/L malt extract; 2 g/L L-ascorbic acid; 5 g/L thiamine hydrochloride). SPME-GC-MS chromatograms of the culture broth and of a culture medium that was not inoculated (as control) were taken (data not shown).

TABLE 10
Biotransformation of media containing different parts of chicken meat by
submerged culture of LSU: Peak areas of identified organosulphuric compounds obtained
by means of SPME-GC-MS. Comparison chemical control without inoculation
and after biotransformation with LSU. Media composition: CMP, 20 g/L;
L-ascorbic acid, 2 g/L; thiamine hydrochloride, 5 g/L.

| | Chicken Meat | | Chicken Broth | | Dehydrated | |
|---|---|---|---|---|---|---|
| | Powder | | Powder | | Chicken Meat | |
| | (18 g/L) | | (10 g/L) | | (10 g/L) | |
| | control | LSU | control | LSU | control | LSU |
| bis-(2-methyl-3-furyl)- | 0 | 5715274 | 0 | 0 | 0 | 0 |
| disulfid | | | | | | |
| dimethyldisulfide | 0 | 0 | 0 | 0 | 0 | 444144 |
| dimethyltrisulfide | 409113 | 472733 | 307592 | 189637 | 182845 | 897648 |
| dithiol, 2-methyl-1,3- | 74640 | 0 | 20463 | 122440 | 0 | 28117 |
| furan, 2-methyl-3- | 0 | 154468217 | 0 | 11978659 | 0 | 36710079 |
| methylthio- | | | | | | |
| furan, 2-methyl-3- | 1089168 | 2460189 | 0 | 0 | 0 | 0 |
| methyldithio- | | | | | | |
| furan, 2-methyl-3- | 0 | 461901 | 0 | 0 | 0 | 0 |
| methyltrithio- | | | | | | |
| methyl-1- | 0 | 0 | 47488 | 112343 | 0 | 0 |
| propenyldisulfid, trans- | | | | | | |

8.3 Biotransformation of Media Containing Parts of Plants of the Genus Allium

Plant parts of the genus Allium, here using onion pomace as an example, was then investigated as a medium component to produce flavours based on Basidiomycetes. The amino acid composition of the tested onion pomace is shown in FIG. 27.

LSU was then submerged cultivated in a culture medium containing onion pomace (30 g/L fresh onion pomace; 2 g/L L-ascorbic acid; 5 g/L thiamine hydrochloride). SPME-GC-MS chromatograms of the culture broth obtained after cultivation and of a culture medium that was not inoculated (as control) were recorded. The chromatograms are shown in FIG. 28. The biotransformation with submerged cultures of LSU resulted in significant changes in the composition of volatile aroma compounds. Aroma compounds imparting “onion”-like flavor notes, such as dimethyltrisulfide and several isomers of dimethylthiophene, were significantly lower after cultivation with LSU compared to the culture medium (control). This demonstrated the potential of fungal biotransformation to reduce undesired or unpleasant flavor notes. Furthermore, the biotransformation enriched the culture with organosulfur aroma compounds with “meat”-like notes, such as 2-methyl-3-(methylthio)-furan and tentatively identified isomers of dimethylmethylthiothiophene. This further supported the hypothesized bioconversion of dimethylthiophenes towards dimethylmethylthiothiophenes by the tested fungal mycelium, as mentioned above.

Similar experiments as above were then performed with celery flour (20 g/L), leek powder (20 g/L), onion extract (15-55 g/L) and onion pomace (fresh, 30-35 g/L) as Allium-based medium components. The culture media further contained 1-2 g/L L-ascorbic acid and 3-5 g/L thiamine hydrochloride. The peak areas of identified flavour compounds in each culture broth determined by means of SPME-GC-MS are illustrated as boxplots in FIG. 29. For the purpose of simplification, the peak areas of the isomers of dimethylthiophene and dimethylmethylthiothiophene were accumulated, respectively.

Another LSU cultivation was carried out with MYD-medium supplemented with onion oil (7.5 μl/L). SPME-GC-MS chromatograms of the culture broth obtained after cultivation and of a blank culture medium that was not inoculated (as control) are shown in FIG. 30. Simultaneously as in FIG. 28, it was found that the developed fermentation platform altered the composition of volatile aroma compounds of the used onion oil. Undesired flavor molecules were reduced, whereas highly potent compounds with desired flavour attributes were generated due to the metabolic conversion by the fungal mycelium.

1.-15. (canceled)

16. a process for producing one or more flavorings selected from non-saturated aldehydes, non-saturated lactones, or organosulphuric compounds, the process comprising:
(a) providing a culture medium comprising one or more components supporting growth of a fungus of phylum Basidiomycota and convertible to one or more flavorings selected from non-saturated aldehydes, non-saturated lactones, or organosulfur aroma compounds;
(b) cultivating the fungus of the phylum Basidiomycota with the culture medium under conditions that support growth of the fungus and formation of the one or more flavorings; and
(c) optionally, recovering the one or more flavorings.

17. The process of claim 16, wherein the fungus is mycelium.

18. The process of claim 16, wherein the one or more flavorings include at least two compounds, wherein at least one of the two compounds is selected from non-saturated lactones.

19. The process of claim 16, wherein the flavoring exhibits one or more odor or taste notes selected from mushroom-like, sulfurous vegetables, deep fried, greasy, roasted, meaty, deep-fried bacon, brothy, chicken skin, or a combination thereof.

20. The process of claim 16, wherein the fungus is selected from Laetiporus, Mycetinis, Marasmius, Lentinula, or Marcrolepiota.

21. The process of claim 20, wherein the fungus is selected from Laetiporus sulphureus, Mycetinis scorodonius, Marasmius alliaceus, Lentinula edodes, Marcrolepiota procera, Laetiporus persicinus, Laetiporus portentosus and Laetiporus montanus, in particular Laetiporus sulphureus, Laetiporus persicinus, Laetiporus montanus, or Laetiporus portentosus.

22. The process of claim 16, wherein the culture medium comprises a food raw material, a food side-stream, or a combination thereof.

23. The process of claim 16, wherein the culture medium comprises a sulfur source.

24. The process of claim 23, wherein the sulfur source is selected from thiamine, cysteine, glutathione, methionine, or combinations thereof.

25. The process of claim 24, wherein the sulfur is thiamine.

26. The process of claim 23, wherein the sulfur source is in an amount from 0.1 g/L to 10 g/L, relative to a total volume of the culture medium.

27. The process of claim 16, wherein the culture medium comprises an antioxidant.

28. The process of claim 27, wherein the antioxidant is L-ascorbic acid.

29. The process of claim 28, wherein the L-ascorbic acid is in an amount from 0.1 g/L to 10 g/L, relative to a total volume of the culture medium.

30. The process of claim 16, wherein cultivation is carried out at a pH of 1.5 to 6 for at least 12 hours at a temperature of 15° C. to 35° C.

31. A process for producing a natural flavoring having a meat-like note comprising:
(a) providing a culture medium comprising one or more components supporting growth of a fungus of phylum Basidiomycota and convertible to one or more flavorings having a meat-like note;
(b) cultivating the fungus of the phylum Basidiomycota with the culture medium under conditions that support growth of the fungus and formation of the one or more flavorings having a meat-like note; and
(c) optionally, recovering the one or more flavorings having a meat-like note;
wherein the culture medium comprises a food raw material, a food side-stream, or a combination thereof selected from vegetables or parts thereof, fruits or parts thereof, grains or parts thereof, microbial cultures or parts thereof, animal parts, or combinations thereof.

32. The process of claim 31, wherein the culture medium comprises a food raw material, a food side-stream, or a combination thereof selected from plants or parts of plants from genus Allium.

33. The process of claim 31, wherein the culture medium comprises a food raw material, a food side-stream, or a combination thereof selected from onion, garlic, leek, celery, carrot, apple, or combinations thereof; animal parts selected from meats, fats, bones, or combinations thereof; or microbial cultures or parts thereof selected from yeasts.

34. The process of claim 31, wherein the culture medium comprises onion pomace, chicken fat, or a combination thereof, and further optionally comprises a sulfur source, an antioxidant, or a combination thereof.

35. A composition prepared according to the process of claim 16 comprising at least one compound selected from non-saturated aldehydes, non-saturated lactones, organosulphuric compounds, or a combination thereof.
